(19) United States
(12) Patent Application Publication
(10) Pub. No.: US 2023/0313544 A1
(43) Pub. Date: Oct. 5, 2023

(54) UNIFORMLY-HEATING SYSTEM FOR CURING CONCRETE

(71) Applicant: KOREA RAILROAD RESEARCH INSTITUTE, Uiwang-si (KR)

(72) Inventors: Tae Hoon KOH, Yongin-si (KR); Han Ju YOO, Suwon-si (KR); Joon Woo PARK, Seongnam-si (KR); Chang Ju KIM, Incheon (KR)

(21) Appl. No.: 18/331,916

(22) Filed: Jun. 8, 2023

Related U.S. Application Data
(63) Continuation of application No. PCT/KR2021/018463, filed on Dec. 7, 2021.

(30) Foreign Application Priority Data
Dec. 11, 2020 (KR) 10-2020-0173647

(51) Int. Cl. E04G 21/06; H05B 3/28

(52) U.S. Cl. CPC E04G 21/06; H05B 3/286; H05B 2203/003

(57) ABSTRACT

Provided is a uniformly-heating system for curing concrete. A uniformly-heating system for curing concrete according to an embodiment of the present application includes a plurality of unit heating devices each is coupled to an external panel of a form for concrete manufacturing in a in close contact state therewith, and a power supply unit that supplies power to the plurality of unit heating devices, wherein the unit heating device includes a body housing that is attached to a surface of the form and has a predetermined unit area, a gripping portion that is coupled to an upper surface of the body housing, and a planar heating heater that is coupled to a lower surface of the body housing.

### BACKGROUND

### 1. Field

The present disclosure relates to a uniformly-heating system for curing concrete.

### 2. Description of the Related Art

A form refers to a temporary structure used until the concrete hardens in the process of manufacturing a concrete structure. The form is a temporary structure, so it is common to separate the form and reuse the form when the curing of concrete is completed. The concrete structure may be mass-produced in a factory or manufactured at a construction site depending on its type or need. The form is essential to accurately secure the shape and dimensions of a concrete structure whether the concrete structure is mass-produced in a factory or manufactured on-site.

In a manufacturing method of a concrete structure using the known form, a form is generally installed according to the shape of a concrete structure to be manufactured, a reinforcing bar assembly, and the like are installed therein, and then concrete is poured and then cured.

In the manufacturing process of the concrete structure using the form, the most important factor affecting the construction period is the curing time. That is, since the longer the curing time, the longer the construction period is, which causes the construction cost to increase. In particular, when the outdoor temperature is low, such as in winter or in a cold region, the curing time is long, thereby resulting in a long construction period, which increases the overall construction cost and makes it difficult to meet the delivery date according to the construction. Moreover, in the case of winter, there is a problem in securing the quality of concrete due to delay in hydration reaction and the like, so that additional additives and the like are used or concrete pouring itself is not performed.

In manufacturing tall buildings such as piers and buildings, it is common to use a form type of Euro form, slip form, or climbing form that cures the concrete structure from the bottom. In this case, there is a problem in that the entire construction period is prolonged because the time required for curing concrete at the time of one concrete pouring lasts for a very long time. In particular, when the outside temperature is low, such as in winter or in a cold region, this problem occurs more significantly, so knownly, in order to shorten the construction period, a construction method is used in which a heating wire is inserted into the form to heat the form, or a method is used in which a hot air blower, stove, boiler, and the like are used to heat the form surface.

However, the method of raising the temperature using the heating wire requires additional complicated electrical work because the heating wire must be installed in the form. Also, since electricity must be continuously supplied to the heating wire, there is a problem in that a huge amount of electricity is consumed. The heating wire must be disassembled, and thereby there is a problem in that the disassembly work is complicated.

In addition, in order to heat the form surface with a hot air blower, stove, boiler, and the like, there are problems in that a huge amount of oil, gas and electricity is consumed to operate the hot air blower, stove, boiler, and the like, the safety of workers is difficult to be guaranteed due to the generation of toxic gas, and there is a possibility of environmental pollution. Therefore, due to these problems, concrete pouring and curing for the construction of concrete structures such as piers or buildings may be stopped in winter, thereby causing the construction period to be prolonged.

The existing method had the above problems, so its use was limited, and even if the construction was performed, it was difficult to proceed with the construction of concrete structures in winter due to problems such as safety problems, environmental problems, and excessive construction costs.

In order to solve these problems of the prior art, the present applicant filed Korean Patent Application Nos. 10-2011-0130015 (title of invention: heating form for manufacturing precast concrete using microwaves), 10-2011-0130016 (title of invention: method for constructing concrete bridge foundation using form heated by microwaves), 10-2012-0031331 (title of Invention: method for constructing building using heating form heated by microwaves), and 10-2012-0031340 (title of invention: form structure for tunnel concrete lining construction using form heated by microwaves and tunnel concrete lining construction method using the same). In these applications, a new technology was proposed in which when the outside temperature is low, such as in winter or in a cold region, the temperature of the form is raised by microwaves without problems of taking a long curing time and using a huge amount of fossil fuels such as oil and gas to raise the temperature required for curing, and thereby the construction period and production period of concrete structures according to concrete curing may be shortened.

When using the above patented technologies, the construction and production of concrete structures may be effectively implemented in the winter season due to the excellent heat generation efficiency and the resulting concrete accelerated curing effect. However, there is a problem in that uniform heat is not achieved as a whole because it is not easy to transfer the microwave uniformly to the heating element, and in the event of a failure of the microwave generator, the entire system does not operate, thereby resulting in construction defects. In addition, the weight and volume of the heating system are excessively large, thereby resulting in poor handling and workability at the actual site.

### SUMMARY

The present application is intended to solve the problems of the prior art described above, and an object of the present disclosure is to provide a uniformly-heating system for curing concrete in which in the constructing and manufacturing on-site pouring and of precast concrete such as bridge foundations of piers and bridges, slabs of buildings such as apartments, houses, and office buildings, tunnel concrete linings, bridge decks, girders, boxes, beams, culverts, retaining walls, piles, track slabs, and concrete sleepers, an initial hydration time of the concrete poured inside the form may be shortened by heating the form using a uniformly-heating system of a new structure and, in particular, a construction period of a concrete structure may be significantly shortened in environments with a low outside temperature such as in winter or in a cold region, and construction defects and workability may be drastically improved.

However, technical problems to be achieved by the present embodiment is not limited to the technical problems described above, and other technical problems may exist.

As technical means for solving the above technical problem, a uniformly-heating system for curing concrete according to an embodiment of the present application includes a plurality of unit heating devices each is coupled to an external panel of a form for concrete manufacturing in a in close contact state therewith; and a power supply unit that supplies power to the plurality of unit heating devices, in which the unit heating device includes a body housing that is attached to a surface of the form and has a predetermined unit area, a gripping portion that is coupled to an upper surface of the body housing, and a planar heating heater that is coupled to a lower surface of the body housing.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view in which a uniformly-heating system for curing concrete according to an embodiment of the present disclosure is mounted on an external panel of a form;

FIG. 2 is a perspective view of a unit heating device of the uniformly-heating system for curing concrete according to an embodiment of the present disclosure;

FIG. 3 is a perspective view of a planar heating heater according to a first embodiment of the present disclosure;

FIG. 4 is a diagram showing a heat distribution diagram of a known unit heating device and a unit heating device according to an embodiment of the present disclosure;

FIG. 5 is a sectional view of a planar heating heater according to a second embodiment of the present disclosure;

FIG. 6 is a plan view of a planar heating heater according to a third embodiment of the present disclosure;

FIG. 7 is a view for explaining a configuration of fixing a unit heating device according to an embodiment of the present disclosure to a form; and

FIG. 8 is a view for explaining a configuration of fixing a unit heating device according to another embodiment of the present disclosure to a form.

### DETAILED DESCRIPTION

Hereinafter, embodiments of the present application will be described in detail so that those skilled in the art may easily practice with reference to the accompanying drawings. However, the present application may be implemented in many different forms and is not limited to the embodiments described herein. In order to clearly describe the present application in the drawings, parts irrelevant to the description have been omitted, and similar reference numerals have been attached to similar parts throughout the specification.

Throughout the present specification, when a part is said to be “connected” to another part, this includes not only a case of being “directly connected” but also a case of being “electrically connected” with another element between the two parts.

Throughout the present specification, when a member is said to be located “on” another member, this includes not only a case where a member is in contact with another member, but also a case where another member exists between the two members.

Throughout the present specification, when a part “includes” a certain component, it means that it may further include other components without excluding other components unless otherwise stated. As used throughout the present specification, the terms “about,” “substantially,” and the like are used at or approximating that value when manufacturing and material tolerances inherent in the stated meaning are given, and do not convey the understanding of the present application. Accurate or absolute figures are used to help prevent exploitation by unscrupulous infringers of the disclosed disclosure. The term “step of (doing)” or “step of” as used throughout the present specification does not mean “step for”.

The present application relates to a uniformly-heating system for curing concrete.

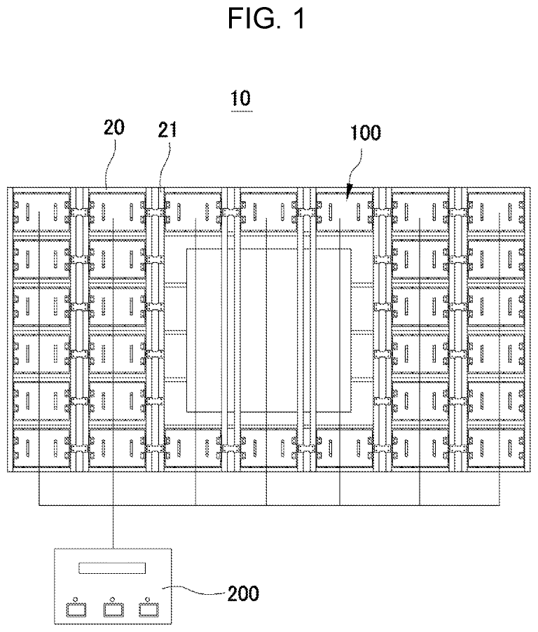

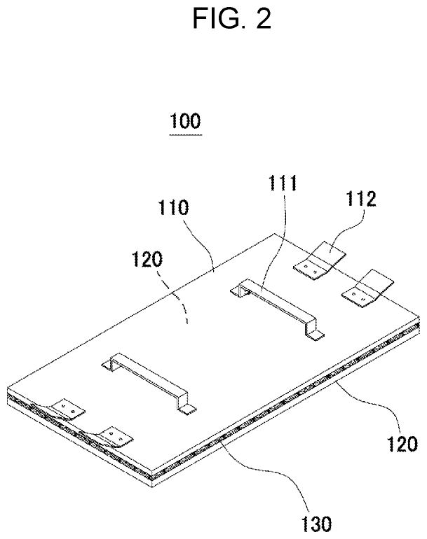

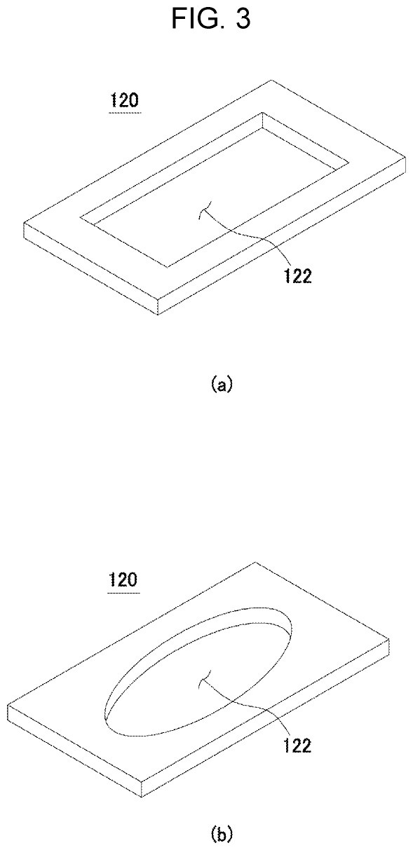

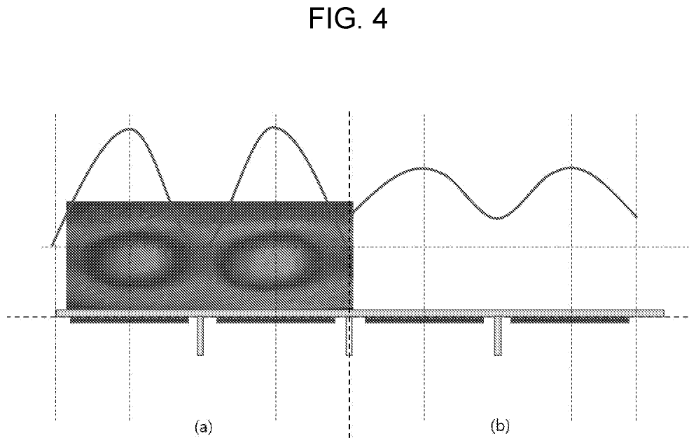

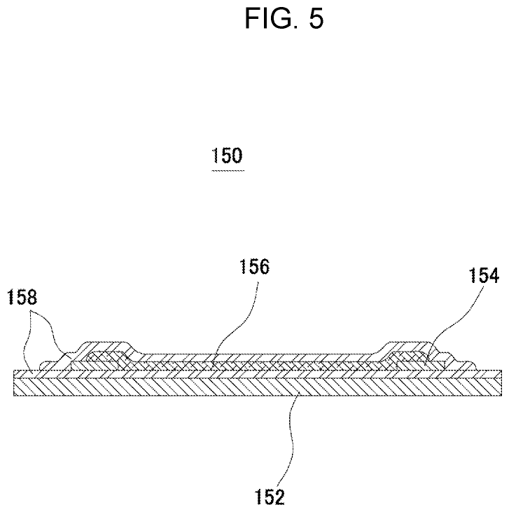

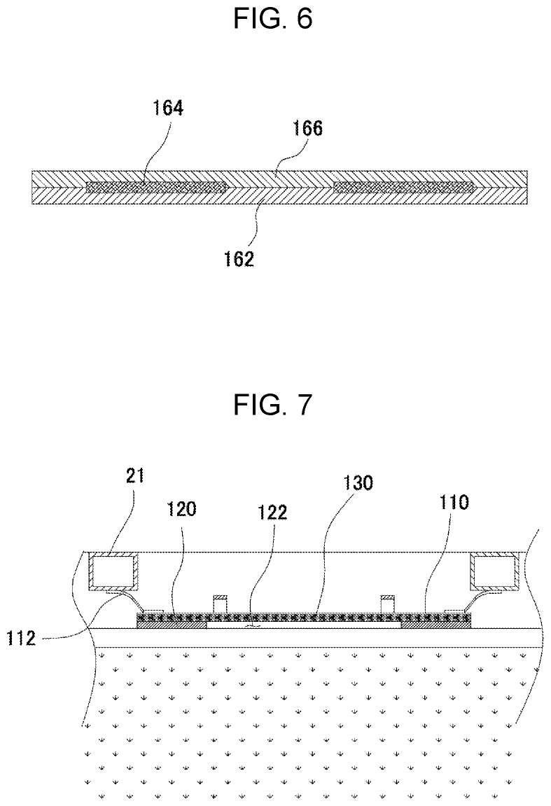

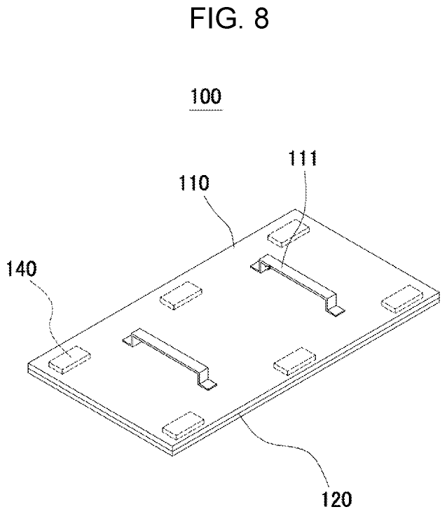

FIG. 1 is a view in which the uniformly-heating system for curing concrete according to an embodiment of the present disclosure is mounted on an external panel of a form, FIG. 2 is a perspective view of a unit heating device of the uniformly-heating system for curing concrete according to an embodiment of the present disclosure, FIG. 3 is a perspective view of a planar heating heater according to a first embodiment of the present disclosure, FIG. 4 is a heat distribution diagram of a known unit heating device and a unit heating device according to an embodiment of the present disclosure, FIG. 5 is a sectional view of a planar heating heater according to a second embodiment of the present disclosure, FIG. 6 is a plan view of a planar heating heater according to a third embodiment of the present disclosure, FIG. 7 is a view for explaining a configuration of fixing a unit heating device according to an embodiment of the present disclosure to a form, and FIG. 8 is a view for explaining a configuration of fixing a unit heating device according to another embodiment of the present disclosure to a form.

Hereinafter, with reference to FIG. 1, a uniformly-heating system 10 for curing concrete according to an embodiment of the present application will be described.

Referring to FIG. 1, the uniformly-heating system 10 for curing concrete includes a plurality of unit heating devices 100 each generates heat by being coupled to a surface of a form for concrete manufacturing made of metal such as aluminum or steel in a close contact state therewith, and a power supply unit 200 that supplies power to the plurality of unit heating devices 100. Illustratively, as shown in FIG. 1, the plurality of unit heating devices 100 are attached to the surface of the form 20 in a lattice form, and the plurality of unit heating devices 100 are supplied with power via the power supply unit 200. Therefore, the form 20 is heated so that hydration and curing of the concrete may be promoted. In addition, since the unit heating device 100 only needs to be separated from the form 20 after the concrete is manufactured, a complicated operation for separation and disassembly is not required, and the heating system 10 may be easily reused.

Hereinafter, referred to FIG. 2, the unit heating device 100 of the present disclosure will be described.

As shown, the unit heating device 100 includes a body housing 110, a gripping portion 111, and a planar heating heater 120.

The body housing 110 is attached to the surface of the form 20 and may have a predetermined unit area. In addition, the body housing 110 is formed in a plate shape, and the planar heating heater 120 may be located at a lower portion thereof.

The gripping portion 111 may be coupled to an upper surface of the body housing 110. Illustratively, as shown in FIG. 2, the gripping portions 111 may be located at a predetermined distance apart in left and right directions on the upper surface of the body housing 110, and accordingly, the unit heating device 100 may be easily attached or detached to or from the surface of the form 20. The left and right directions described above may be directions of 2 o'clock and 8 o'clock in FIG. 2.

The planar heating heater 120 is coupled to the lower surface of the body housing 110 and may be in close contact with the surface of the form 20. In addition, the planar heating heater 120 receives power from the power supply unit 200 and generates heat, and uses the heat generated at this time to transfer heat to the surface of the form 20 and thereby heat energy may be transferred to concrete located inside the form 20. Through this, hydration and curing of concrete may be promoted.

In addition, the unit heating device 100 may further include a heat insulating member 130 located between the body housing 110 and the planar heating heater 120. The heat insulating member 130 minimizes the transfer of thermal energy generated in the planar heating heater 120 to the body housing 110 and efficiently transfers the thermal energy to the surface of the form 20.

Hereinafter, the planar heating heater 120 according to various embodiments of the present disclosure will be described with reference to FIGS. 2 to 6.

Referring to FIG. 3, the planar heating heater 120 may be formed in a rectangular plate shape and may include a perforation hole 122 at a center portion. At this time, the perforation hole 122, as shown in FIG. 3, may be formed in a rectangular or elliptical shape, but is not limited thereto.

FIG. 4 is a diagram showing a heat distribution diagram of a known unit heating device and the unit heating device 100 according to an embodiment of the present disclosure.

Referring to FIG. 4, the heat distribution in the known unit heating device is not uniform because the heat is concentrated in the center portion, whereas the unit heating device 100 of the present disclosure has the perforation hole 122 in the center portion of the planar heating heater 120, thereby capable of minimizing the phenomenon in which heat is concentrated and transferred to the center portion. Therefore, there is an effect of uniformly transferring heat to the form 20.

As another embodiment, referring to FIG. 5, a planar heating heater 150 may include a conductor 154, a heating unit 156, an insulation 158, and a heating plate 152.

The conductor 154 may receive power from the power supply unit 200. In this case, the conductor 154 may increase electrical conductivity and lower contact resistance by using silver as a main component.

The heating unit 156 has a predetermined area and may generate heat by receiving power from the conductor 154. In addition, the heating unit 156 is formed in a donut-like plate shape, so that heat concentration in the center portion of the heating plate 152 may be minimized.

The insulation 158 may be formed to surround the heating plate 152 and the conductor 154. Illustratively, the planar heating heater 150 may be manufactured by applying the insulation 158 to an upper portion of the heating plate 152, mounting the conductor 154 and the heating unit 156 on the upper portion of the applied insulation 158, and then applying again the insulation 158 to the upper portion of the conductor 154 and the heating unit 156.

At this time, the insulation 158 serves to improve electrical heat transfer performance and prevent the planar heating heater 150 from being damaged and oxidized by a physical external force. To this end, the insulation 158 may include at least one of barium titanate (BaTiO3), glass, glass-ceramic, borosilicate, and aluminum silicates, but is not limited thereto.

In addition, when the insulation 158 is coated and hardened 3 times, an dielectric withstand voltage of 1 KV or more may be obtained with a thickness of 75 um, and when being coated and hardened 4 times, an dielectric withstand voltage of 4.5 KV or more may be obtained with a thickness of 100 um. Therefore, depending on the use environment, the predetermined number of times of coating and hardening may be selectively used.

The heating plate 152 may be located on the lower portion of the insulation 158 and formed in a plate shape. In this case, the heating plate 152 may use alumina, stainless steel, SUS 430, 444 series or a material having a linear expansion coefficient similar thereto.

In another embodiment, referring to FIG. 6, a planar heating heater 160 may include a lower plate 162, a heating unit 164, and an upper plate 166.

The lower plate 162 is formed in a plate shape having a predetermined area and may be made of a heat-resistant polyethylene terephthalate (PET) material. In addition, the lower plate 162 may implement high-temperature heat generation by using PET which is flexible and has a high heat resistance temperature among PETs.

The heating unit 164 may be disposed on an upper portion of the lower plate 162 and generate heat by receiving power from the power supply unit 200. In addition, the heating unit 164 is manufactured in a form of a wire made of stainless steel (STS) material, and the wire-shaped heating unit 164 may be bent and patterned to be mounted on the upper portion of the lower plate. In this case, the overall shape of the heating unit 164 is formed in a donut shape, so that concentration of heat in the center portion of the lower plate 162 may be minimized.

The upper plate 166 is located on an upper portion of the heating unit 164 and may have the same material as that of the lower plate 162. In addition, the upper plate 166 may be coupled to the upper portion of the lower plate 162 through thermal fusion, but is not limited thereto. In addition, the upper plate 166 and the lower plate 162 may be configured to electrically insulate the heating unit 164 from the outside, thereby serving to safely protect the heating unit 164.

In addition, the planar heating heater 160 may be manufactured by coating a carbon heating element on a flexible PET material.

Hereinafter, referring to FIGS. 7 and 8, a configuration for fixing the unit heating device 100 according to an embodiment of the present disclosure to the form 20 will be described.

Referring to FIG. 7, the unit heating device 100 may further include one or more plate-shaped spring fastening portions 112 each coupled to the left and right sides of the body housing 110 and having a fastening state with the support frame 21 of the form 20. Illustratively, the plate-shaped spring fastening portions 112 may be located on the left and right sides of the body housing 110, respectively, and one end may be fixed to the upper surface of the body housing 110, and the other end thereof may be located so as to extend upward on the outside.

When the unit heating device 100 is installed in the form 20, an end portion of the plate-shaped spring fastening portion 112 presses the lower surface of the support frame 21 of the form 20, so that the unit heating device 100 may be located so as to be in close contact with the surface of the form 20. Accordingly, there is an effect of efficiently transferring heat generated from the planar heating heater 120 to the surface of the form 20.

In another embodiment, referring to FIG. 8, the unit heating device 100 may further include a plurality of magnet portions 140 located on the lower surface of the body housing 110 and spaced apart from each other by predetermined distances. In other words, the unit heating device 100 may be fixed to the surface of the form 20 by the magnetic force of the plurality of magnet portions 140.

In this case, as shown in FIG. 8, the plurality of magnet portions 140 may be located in the vicinity of front and rear corners of the body housing 110 by three, respectively, but the number or location of the magnet portions 140 is not limited thereto.

According to the above-described problem solving means of the present application, the installation of a plurality of unit heating devices is completed simply by attaching the unit heating devices to the form for concrete manufacturing and supplying power, so there are effects that an operation is very easy, and hydration and curing of concrete are promoted by heat generated by the heating system without separately supplying curing cloth or steam.

In addition, the uniformly-heating system for curing concrete according to the present disclosure may satisfy the quality of the cured concrete, such as strength and durability, more than the required quality, and in particular, it is possible to ensure uniform heat generation and thus uniform quality as a whole.

In addition, since the present disclosure only needs to separate the heating system from the panel of the form after the preparation of the concrete is completed, there is no need for a complicated operation for separation and disassembly, and it is easy to reuse the heating system.

The above description of the present application is for illustrative purposes, and those skilled in the art will understand that it may be easily modified into other specific forms without changing the technical spirit or essential features of the present application. Therefore, the embodiments described above should be understood as illustrative in all respects and not limiting. For example, each component described as a single type may be implemented in a distributed manner, and similarly, components described as distributed may be implemented in a combined form.

The scope of the present application is indicated by the following claims rather than the detailed description above, and all changes or modifications derived from the meaning and scope of the claims and equivalent concepts thereof should be construed as being included in the scope of the present application.

What is claimed is:

1. A uniformly-heating system for curing concrete comprising:
a plurality of unit heating devices each is coupled to an external panel of a form for concrete manufacturing in a in close contact state therewith; and
a power supply unit that supplies power to the plurality of unit heating devices,
wherein the unit heating device comprises:
a body housing that is attached to a surface of the form and has a predetermined unit area;
a gripping portion that is coupled to an upper surface of the body housing; and
a planar heating heater that is coupled to a lower surface of the body housing.

2. The uniformly-heating system for curing concrete according to claim 1, wherein the planar heating heater includes a perforation hole formed in a center portion.

3. The uniformly-heating system for curing concrete according to claim 2, wherein the perforation hole is formed in a rectangular or elliptical shape.

4. The uniformly-heating system for curing concrete according to claim 1, wherein the planar heating heater comprises:
a conductor receiving power from the power supply;
a heating unit having a predetermined area and generating heat by receiving power from the conductor;
an insulation surrounding the heating unit and the conductor; and
a heating plate located in a lower portion of the insulation.

5. The uniformly-heating system for curing concrete according to claim 4, wherein the heating unit is formed in a donut shape.

6. The uniformly-heating system for curing concrete according to claim 1, wherein the planar heating heater comprises:
a lower plate having a predetermined area and made of heat-resistant polyethylene terephthalate (PET) material;
a heating unit disposed in the upper portion of the lower plate and generating heat by receiving power from the power supply unit; and
an upper plate located on the upper portion of the heating unit and having the same material as that of the lower plate.

7. The uniformly-heating system for curing concrete according to claim 6, wherein the heating unit is formed by bending and patterning a wire of stainless steel (STS) material, and an overall shape thereof is formed in a donut shape.

8. The uniformly-heating system for curing concrete according to claim 1, further comprising:
an insulating member located between the body housing and the planar heating heater.

9. The uniformly-heating system for curing concrete according to claim 1, further comprising:
one or more plate-shaped spring fastening portions each coupled to left and right sides of the body housing and having a fastening state with the form.

10. The uniformly-heating system for curing concrete according to claim 1, further comprising:
a plurality of magnet portions located on the lower surface of the body housing and spaced apart from each other by predetermined distances.
